(19) United States
(12) Patent Application Publication
(10) Pub. No.: US 2013/0284409 A1
(43) Pub. Date: Oct. 31, 2013

(54) Heat Exchanger And Associated Method Of Forming Flow Perturbators

(71) Applicants: Laurent Odillard, Le Luart (FR); Alan Day, Thillois (FR)

(72) Inventors: Laurent Odillard, Le Luart (FR); Alan Day, Thillois (FR)

(73) Assignee: Valeo Systemes Thermiques, Le Mesnil Saint Denis (FR)

(21) Appl. No.: 13/883,907

(22) PCT Filed: Nov. 7, 2011
(86) PCT No.: PCT/EP2011/069577

§ 371 Date: Jul. 18, 2013

(30) Foreign Application Priority Data
Nov. 9, 2010 (FR) FR 10/59222

(51) Int. Cl. B60K 11/06; F28F 13/12

(52) U.S. Cl. CPC B60K 11/06; F28F 13/12
USPC 165/109.1; 29/890.03

(57) ABSTRACT

The invention relates to a heat exchanger for the exchange of heat between first and second fluids. The heat exchanger includes first circulation canals for the circulation of the first fluid in a first direction of circulation (D1), and second circulation canals for the circulation of the second fluid, and perturbation walls arranged in the second circulation canals for the second fluid and having perturbators that perturb the flow of the second fluid. The perturbation walls respectively have at least one dividing rib. The at least one rib extends in a second direction (D2) substantially perpendicular to the first direction in which the first fluid circulates, and over a predefined distance of the wall that is less than the total width of the wall in the second direction, so as to define at least two circulation passes for the second fluid substantially perpendicular to the circulation of the first fluid.

The invention relates to a heat exchanger, notably for a motor vehicle. The invention also relates to a shaping method.

A preferred field of application of the invention is that of supercharged combustion engines, notably for motor vehicles, which use a special kind of heat exchanger also known as a charge air cooler (abbreviated to CAC) to cool a fluid, namely the charge air used to supercharge the engine.

Supercharged, or turbocharged, combustion engines, particularly diesel engines, are supplied with pressurized air known as the charge air which comes from a turbocharger driven by the engine exhaust gases. Because it has been compressed, this air is at too high a temperature and it is desirable, for correct engine operation, that it be cooled before it is admitted to this engine. To that, in the conventional way, use is made of a cooler known as a charge air cooler. The purpose of this cooler is to cool the charge air by exchange of heat with another fluid such as the external air or a liquid such as the water from the engine cooling circuit, thus forming an exchanger of the air/air or liquid/air type.

The circulation of the two fluids is of great importance to the performance of the heat exchanger.

In one known solution, one of the fluids or both fluids are made to circulate through perturbators in order to increase the surface areas available for the exchange of heat between the two fluids.

It is an objective of the invention to improve the quality of the exchanges of heat between the two fluids.

To that end, one subject of the invention is a heat exchanger for the exchange of heat between a first and a second fluid, notably for a motor vehicle, comprising;
First circulation canals for the circulation of the first fluid in a first direction of circulation, and second circulation canals for the circulation of the second fluid, and
Perturbation walls arranged in the second circulation canals for the second fluid and having perturbators that perturb the flow of the second fluid,

characterized in that the perturbation walls respectively have at least one dividing rib, said at least one rib extending in a second direction substantially perpendicular to the first direction in which the first fluid circulates, and over a predefined distance of said wall that is less than the total width of said wall in the second direction, so as to define at least two circulation passes for the second fluid substantially perpendicular to the circulation of the first fluid.

Said may further comprise one or more of the following features, considered separately or in combination:
said perturbators are produced on said wall by the bending of said wall;
a perturbation wall comprises a predefined number of dividing ribs arranged top to tail;
a perturbation wall comprises a predefined number of dividing ribs placed evenly;
said perturbators have a somewhat crenellated overall appearance;
said perturbators are arranged in rows in a staggered configuration;
said dividing ribs are formed as one piece with perturbators which extend over the same distance as said dividing ribs;
said exchanger comprises a bundle of tubes forming the first circulation canals for the circulation of the first fluid and defining between them the second circulation canals for the circulation of the second fluid;
said exchanger comprises a bundle of parallel plates arranged in pairs so as to define the first circulation canals for the circulation of the first fluid between two pairs of plates and the second circulation canals for the circulation of the second fluid between the plates of one pair;
said exchanger is configured to cool the charge air of a motor vehicle engine;
the first fluid is the charge air and the second fluid is a cooling fluid.

The invention also relates to a method for forming perturbators on a perturbation wall of a heat exchanger as defined herein above and comprising the following steps:
double rows of perturbators are produced as a single piece, and
single rows of perturbators are produced respectively as a single piece with dividing ribs.

Other features and advantages of the invention will become more clearly apparent from studying the following description, given by way of nonlimiting illustrative example, and from studying the attached drawings in which:

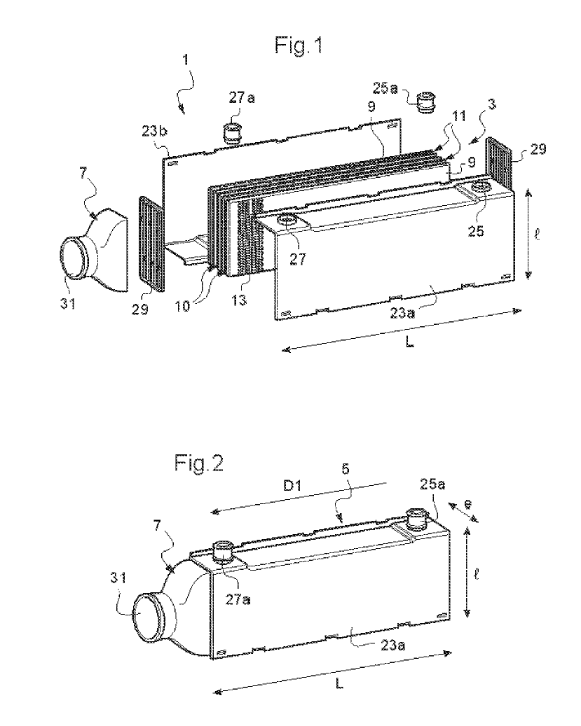

FIG. 1 is an exploded perspective view of components of a heat exchanger according to a first embodiment,

FIG. 2 is a perspective view of the exchanger of FIG. 1, assembled,

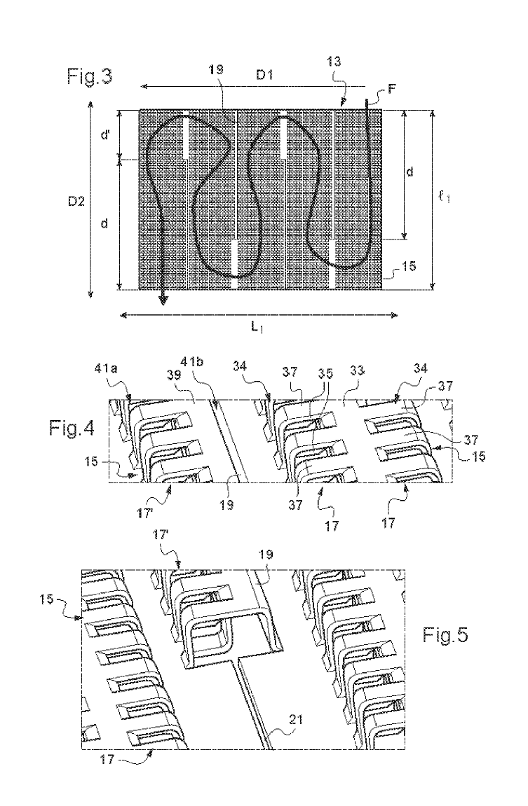

FIG. 3 is a simplified depiction of a perturbation wall for perturbing the flow of the second fluid of the exchanger of FIGS. 1 and 2,

FIG. 4 partially depicts a detail of perturbators formed on the perturbation wall of FIG. 3,

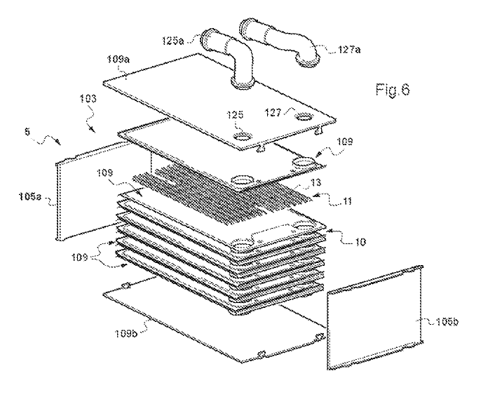

FIG. 5 partially depicts another detail of perturbators and of a dividing rib which are formed on the perturbation wall of FIG. 3,

FIG. 6 is an exploded perspective view of components of a heat exchanger according to a second embodiment,

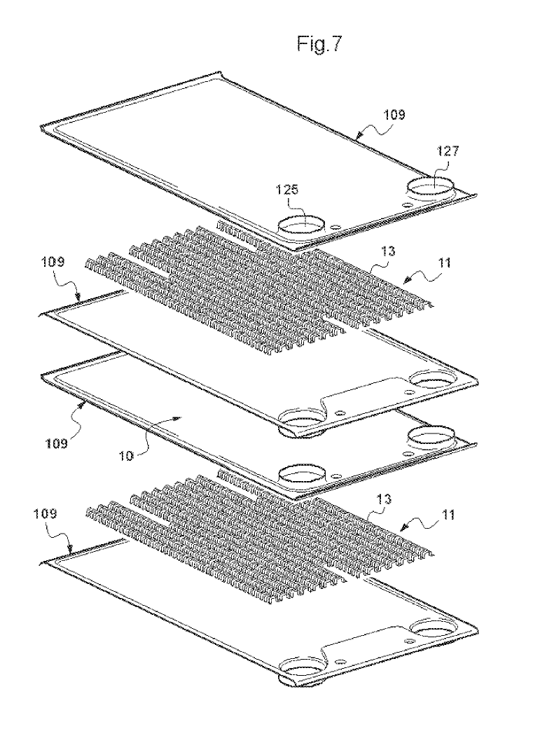

FIG. 7 is an exploded perspective view showing in greater detail two pairs of plates and one perturbation wall between two plates of a pair of plates of a heat exchange bundle according to the second embodiment,

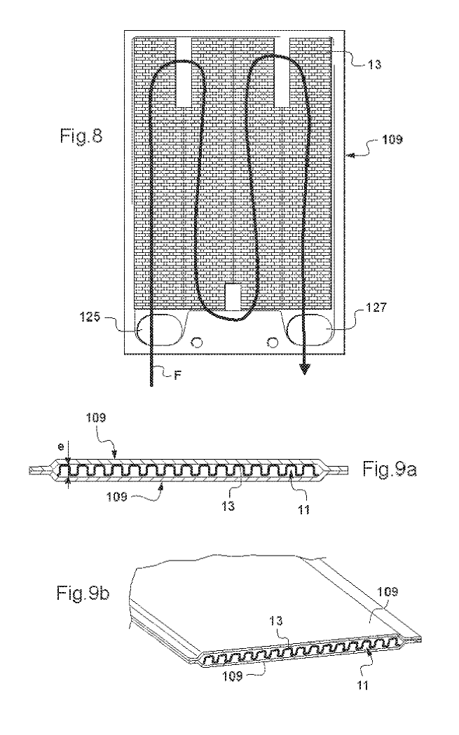

FIG. 8 is a plan view of one plate of the heat exchange bundle according to the second embodiment and of one perturbation wall,

FIG. 9a is a partial view in cross section depicting the pair of plates of FIG. 8 in the assembled state,

FIG. 9b is a partial perspective view depicting the pair of plates of FIG. 8 in the assembled state.

In these figures, elements that are substantially identical bear the same references.

FIG. 1 depicts an exploded view of a heat exchanger 1 and FIG. 2 is a view in the assembled state.

In particular, the exchanger 1 described is configured to cool the charge air of a combustion engine, such as a motor vehicle diesel engine.

Such an exchanger 1 may be what is known as an “air-water” exchanger, namely an exchanger in which the fluids that exchange heat are air and water. In the case of a charge air cooler, the water is preferably the water, referred to as “low temperature”, of the cooling circuit of said engine and is typically glycol water.

This exchanger 1 comprises:
a heat exchange bundle 3 for exchanging heat between a first fluid such as the charge air and a second fluid such as the coolant,
a casing 5 accommodating the heat exchange bundle 3,
an inlet header 7 for the first fluid,
an outlet header for the first fluid (this is not depicted).

With reference to FIGS. 1 and 2, the exchanger 1 is of substantially parallelepipedal overall shape having:
a length L, which is the longest dimension, and which corresponds to the overall direction in which the charge air circulates through the exchanger 1, referred to as the first circulation direction D1,
a width l, the length L and width l dimensions forming a plane parallel to the plane of circulation of air through the exchanger 1, and
a thickness e for a stack of circulation tubes 9 as described hereinafter.

The Heat Exchange Bundle

The heat exchange bundle 3 according to a first embodiment comprises a stack of circulation tubes 9 for the circulation of the first fluid, air in this example. The interior volume of each tube 9 forms a first circulation canal 10 for the first fluid.

According to this first embodiment, the tubes 9 are of substantially parallelepipedal and flattened overall shape.

With reference to FIGS. 1 and 2, each tube 9 has:
a length, which is the longest dimension, this dimension being parallel to the length L of the exchanger 1 and substantially equal to the length L,
a width, this dimension being parallel to the width l of the exchanger 1 and substantially equal to the width l, and
a thickness, this dimension being parallel to and less than the thickness e of the exchanger 1; the thickness of each tube 9 is very small in this example because the tubes 9 are of flattened shape.

By way of example, the thickness of the tubes 9 may be equal to around 7 or 8 mm for each tube 9, the width l of the tubes 9 being equal to around 100 mm.

The tubes 9 are stacked parallel to one another in the thickness direction and allow the circulation of air within them, in the overall direction of the length L of the exchanger.

The exchanger 1 depicted in FIG. 1 comprises a bundle 3 of six tubes 9; of course, it could have a lower or higher number of tubes; it should be noted here that, in some instances, the thickness e of the exchanger 1 may be greater than its width l if the number of tubes 9 is great enough.

Further, it is possible to provide within the interior volume of the tubes 9, defining the first canals 10, perturbation fins (not depicted), for example of substantially corrugated shape, so as to perturb the flow of the air through these tubes 9. This perturbation encourages exchanges of heat between the air and the water across the walls of the tubes 9. These fins are well known to those skilled in the art and are not described in further detail herein.

Moreover, the tubes 9 define between them second canals 11 for the flow of the second fluid, glycol water in this example. In other words, the space between two tubes makes it possible to define, in this instance, the second canals 11 for the flow of the second fluid.

Perturbation walls 13 for perturbing the flow of water are formed in these second canals 11 between the tubes 9.

The perturbation walls 13 are, for example, fixed by brazing to the surfaces of the tubes 9 defining a second canal 11.

Such a perturbation wall 13 is depicted in simplified form in FIG. 3. FIG. 1 depicts only a portion of a perturbation wall 13 in order to make that figure easier to understand.

The perturbation walls 13 take the form of plates extending substantially over the entire lateral surface of the tubes 9. The lateral surface means the surface of the tubes 9 which is defined by the dimensions parallel to the length L and to the width l of the exchanger 1. A perturbation wall 13 therefore has a substantially rectangular overall shape with a length L₁ parallel to the length L and a width l₁ parallel to the width l of the exchanger 1.

According to the embodiment described, a perturbation wall 13 fills the entire thickness of the second water circulation canal 11 in which it is located.

The perturbation walls 13 are mounted between all the tubes 9. Perturbation walls 13 may also be mounted between the end tubes 9 of the bundle 3 and the walls of the casing 5.

The perturbation walls 13 have a shape that creates turbulence in the flow of water passing through them.

More specifically, a perturbation wall 13 has perturbators 15 (better visible in FIGS. 4 and 5) defining more or less crenellated patterns. These more or less crenellated patterns make, in the example illustrated, right angles.

These patterns are, for example, created by bending a single component: namely the wall 13.

The perturbation walls 13 have these patterns which are more or less crenellated in our example, both in the direction parallel to the width l of the exchanger 1 and in the direction parallel to the length L of the exchanger 1.

More specifically, the perturbators 15 are arranged in rows 17, 17′, these rows 17; 17′ being arranged in a staggered configuration, each row 17, 17′ defining the more or less crenellated patterns.

Further, with reference to FIGS. 3 to 5, the perturbation walls 13 respectively comprise one or more dividing rib(s) 19 defining circulation passes for the water in this example. These ribs 19 act as a barrier to the water forcing the water to pass along the circulation passes.

The path of the water along these circulation passes is illustrated schematically by the somewhat wavy arrow F in FIG. 3.

In the example illustrated in FIG. 3, four dividing ribs 19 are depicted. Of course, the number of ribs 19 has to be adapted to suit the performance requirements for the exchanger 1.

These ribs 19 extend in a second direction D2 substantially perpendicular to the first direction D1 of circulation of the air, and over a predefined distance. In this instance, the ribs 19 respectively extend over a predefined distance d in the direction of the width l₁ of the wall 13 but over a distance less than the width l₁ of the wall 13 in the direction D2.

The water thus circulates substantially perpendicular to the circulation of the air.

In addition, these ribs 19 are arranged top to tail, which means that in each pair, the ribs 19 extend in opposite directions starting from two opposite edges of the wall 13.

The path of the water depicted schematically is obtained by arranging the dividing ribs top to tail.

In addition, these dividing ribs 19 are evenly spaced and extend respectively over a predefined distance d in the direction of the width l₁ of the wall 13 which is less than this width l₁. This predefined distance d is, in the embodiment described, the same for each rib 19.

Further, as will be noted from FIGS. 4 and 5, the dividing ribs 19 are formed as a single piece with perturbators 15, more specifically with single rows 17′ of perturbators 15. In this case, the perturbators 15 extend over the same distance d as the dividing ribs 19 rather than over the entire width l₁ of the perturbation wall 13, unlike the other perturbators. In the region of these ribs 19 there are, therefore, zones 20 without perturbators 15 over the rest of the width l₁ of the perturbation wall 13. More specifically, a rib 19 extends over the distance d and an unencumbered zone 20 extends over a distance d′, the two distances d and d′ when added together being equal to the width l₁ of the wall 13.

Furthermore, with reference to FIG. 5, it may be seen that slots 21 are provided on the perturbation walls 13 to allow the bending that defines the crenellated patterns of the perturbators 15. The purpose of these slots 21 is to avoid surplus material during the bending operation used to create the perturbators 15.

Thus, in the example described in FIGS. 1 to 5, water circulates between the air circulation tubes 9 and its flow is perturbed by the perturbation walls 13, encouraging exchanges of heat with the air across the walls of the tubes 9. In addition, the water circulates more or less perpendicularly in a number of passes, thus further improving the quality of the heat exchanges.

A first embodiment of the core bundle 3 that used a stack of tubes 9 was described hereinabove. According to a second embodiment it is also possible to conceive of a core bundle 103 (FIG. 6) using a stack of parallel plates 109, one pair of plates 109 of which is illustrated in FIG. 7.

A plate 109 (better visible in FIG. 8) has a rectangular overall shape. These plates 109 are, for example, pressed plates.

The plates 109 are arranged in pairs (cf. FIGS. 9a, 9b) to delimit firstly, the first canals 10 for the circulation of the first fluid and, secondly, the second canals 11 for the circulation of the second fluid.

Specifically, the plates 109 arranged in pairs define a space e (FIG. 9a) delimiting a second canal 11 for the circulation of the second fluid, the coolant in our example. The second canals 11 for the circulation of the second fluid are therefore defined by two adjacent plates of a pair.

The space created between two plates 109 provided facing one another of two adjacent plate pairs defines the first canals 10 for the circulation of the first fluid.

Further, as may be seen from FIGS. 6 and 7, the plates 109 respectively have two openings, for example nozzles 125, 127, for the passage of the second fluid arriving from an inlet nozzle 125a to re-emerge via an outlet nozzle 127a. These nozzles 125, 127 are, for example, formed near one of the short sides of the plates 109.

The nozzles 125, 127 of one plate 109 communicate respectively with the nozzles 125, 127 of a plate 109 of an adjacent pair, for example by fitting together, to allow the second fluid to circulate between the plates 109.

In addition, in this second embodiment, provision may be made for the bundle 103 to comprise a first end plate 109a forming a cover and an opposite second end plate 109b. According to the embodiment illustrated, the first end plate 109a bears an inlet nozzle 125a and an outlet nozzle 127a for the second fluid.

These end plates 109a, 109b may form, with two side walls 105a, 105b, the casing 5 that houses the bundle 103 and to which the header boxes for the first fluid are attached.

Moreover, as illustrated in FIGS. 7 to 9b, perturbation walls 13 are arranged in the second circulation canals 11 for the second fluid, so as to improve the exchange of heat by defining circulation passes for the second fluid. The perturbation walls 13 are mounted in all the second canals 11. These walls 13 are substantially identical to the perturbation walls 13 described in the first embodiment of the bundle and are not described again.

Another particular embodiment which has not been illustrated proposes that the perturbation walls 13 that perturb the flow of water and are formed in the second canals 11 between the tubes 9 should have perturbators and at least one dividing rib 19 that allow at least water circulation passes to be defined in our example. In this particular embodiment, the dividing rib 19 is obtained by crushing at least one row of perturbators 15.

Casing

The bundle 3, 103 comprising the first circulation canals 10 possibly with perturbation fins inside them, and the second circulation canals 11 for the water with the perturbation walls 13 is mounted inside a casing 5 (FIGS. 1, 2 and 6) which houses it, as mentioned hereinabove.

Of course, as an alternative, provision may be made for these elements to be mounted in a header box or even in two half-casings.

In the example depicted in FIGS. 1 and 2 regarding the first embodiment of the heat exchange bundle 3, the casing 5 comprises two L-shaped walls 23a, 23b.

The casing 5 also comprises inlet piping 25 and outlet piping 27 for letting water into and out of the exchanger 1, more specifically on the wall 23a in the example illustrated, and connection orifices 25a, 27a associated with a water circuit in which the exchanger 1 is fitted.

To form the casing 5 in its definitive form, the walls 23a, 23b are, for example, brazed together.

In the example illustrated in FIG. 6 regarding the second embodiment of the heat exchange bundle 103, the casing 5 may be formed by end plates 109a, 109b of the bundle 103 and two side walls 105a, 105b, as described hereinabove.

Air Distribution Header

As mentioned earlier, the exchanger 1 comprises, at each of its ends (in the direction of its length L), an air distribution header. On the one hand, an air inlet distribution header 7 and, on the other hand, an air outlet distribution header (not depicted). The outlet distribution header (not depicted) is, according to one embodiment, similar to the inlet header 7 and mounted symmetrically; of course, in another form of embodiment, the inlet and outlet headers may differ.

The ends of the air circulation tubes 9 or of the plates 109, 109a, 109b are connected to the air distribution headers 7 in such a way that the tubes 9 or the plates 109, 109a, 109b open into the headers 7, more specifically via manifolds 29 (FIG. 1). The interior volume of the tubes 9 or defined between two plates 109 of a pair of plates 109 thus being in communication with the interior volume of the distribution headers 7.

The distribution headers 7 are connected to the piping of an air circuit in which the exchanger 1 is mounted and has an inlet nozzle 31 and an outlet nozzle respectively. Air is admitted to the bundle 3, 103 via the inlet distribution header 5 and is collected on leaving the bundle 3, 103 by the outlet distribution header (not depicted).

The structure of the distribution headers is known to those skilled in the art and not described in further detail herein.

Thus, the first fluid, in this instance the charge air, enters the exchanger 1 via the inlet header 7 for the first fluid, circulates through the heat exchange bundle 3, 103 then leaves the exchanger 1 via the outlet header (not depicted) for the first fluid.

As for the second fluid, in this instance the water, that enters the heat exchange bundle 3, 103 via the inlet piping 25 for the second fluid, circulates through the second circulation canals 11 of the heat exchange bundle 3 in one or more circulation passes which are defined by the perturbation walls 13, to exchange heat with the charge air that is to be cooled. This water then leaves the heat exchange bundle 3, 103 via the outlet piping 27 for the second fluid.

How the Perturbators Are Formed

One way of forming the perturbators 15 and dividing ribs 19 on the perturbation walls 13 is now described.

In the known way, the perturbators 15 are produced by bending the wall 13 to form crenellated patterns.

According to the embodiment described:
on the one hand, first crenellated elements or perturbators 15 are produced which are arranged in two rows 17 and formed as a single piece, and
on the other hand, second perturbators 15 are produced which are arranged in a single row 17′ formed as one piece with a rib 19.

As far as the double rows 17 of perturbators 15 are concerned, these being formed as a single piece, a first bend 33 more or less in the overall shape of a U is formed for example, this U-shape having two lateral branches 34. Then second bends 35 more or less in the shape of an L are formed on each lateral branch 34 of the U followed by third bends 37 more or less in the shape of an L facing in the opposite direction to the second bends 35 and intercalated between the second bends 35 so as to define the crenellated shape.

These double rows 17 are, for example, formed across the entire width l₁ of the wall 13.

Further, regarding the creation of the single rows 17′ of perturbators 15 which are formed respectively as one piece with the ribs 19, for example firstly, slots 21 are formed and then, centered on the slots 21, a first bend 39 more or less in the overall shape of a U, for example of a reduced size by comparison with the first bend 33 used to create the double rows 17, is created. In the example illustrated, this U-shaped bend 39 forms more or less half of the bend 33.

Next, and adopting a similar approach to the double rows 17 of perturbators 15, second bends 35′ substantially in the shape of an L and third bends 37′ substantially in the shape of an L and facing in the opposite direction to the second bends 35′ and interpolated between the first bends 35′ are formed on a first lateral branch 41a of the U in order to form a single row 17′ with substantially crenellated perturbators 15.

The second lateral branch 41b of the U formed by the first bend 39 forms a dividing rib 19.

The single rows 17 and the ribs 19 which are formed as a single piece with the single rows 17 are, for example, formed over a distance d less than the width l₁ of the wall 13.

Thus, the presence of the perturbation walls 13 in the circulation canals for the second fluid, water in our example, makes it possible to increase the surface area for heat exchange and the layout of the dividing ribs 19 ensures that the second fluid circulates perpendicular to the first fluid in one or more passes, i.e., in the case of an air/water cooler, that the water circulates in one or more passes substantially perpendicular to the direction D1 in which the air circulates through the exchanger 1.

This further promotes exchanges of heat and does so without the need for components in addition to the perturbation walls 13.

1. A heat exchanger for the exchange of heat between a first and a second fluid, said exchanger comprising:
first circulation canals (10) for the circulation of the first fluid in a first direction of circulation (D1), and second circulation canals (11) for the circulation of the second fluid, and
perturbation walls (13) arranged in the second circulation canals (11) for the second fluid and having perturbators (15) that perturb the flow of the second fluid,
wherein the perturbation walls (13) respectively have at least one dividing rib (19), the at least one rib (19) extending:
in a second direction (D2) substantially perpendicular to the first direction (D1) in which the first fluid circulates, and
over a predefined distance of the perturbation wall (13) that is less than the total width of the perturbation wall (13) in the second direction,
so as to define at least two circulation passes for the second fluid substantially perpendicular to the circulation of the first fluid.

2. The exchanger as claimed in claim 1, wherein the perturbators (15) are produced on the perturbation wall (13) by bending the perturbation wall (13).

3. The exchanger as claimed in claim 1, wherein a perturbation wall (13) comprises a predefined number of dividing ribs (19) arranged top to tail.

4. The exchanger as claimed in claim 1, wherein a perturbation wall (13) comprises a predefined number of dividing ribs (19) placed evenly.

5. The exchanger as claimed in claim 1, said wherein the perturbators (15) have a generally crenellated appearance.

6. The exchanger as claimed in claim 5, wherein the perturbators (15) are arranged in rows (17, 17′) in a staggered configuration.

7. The exchanger as claimed in claim 1, said wherein the dividing ribs (19) are formed as one piece with perturbators (15) which extend over the same distance as the dividing ribs (19).

8. The exchanger as claimed in claim 1, comprising a bundle of tubes (9) forming the first circulation canals (10) for the circulation of the first fluid and defining between them the second circulation canals (11) for the circulation of the second fluid.

9. The exchanger as claimed in claim 1, comprising a bundle of parallel plates (109) arranged in pairs so as to define the first circulation canals (10) for the circulation of the first fluid between two pairs of plates (109), and the second circulation canals (11) for the circulation of the second fluid between the plates (109) of one pair.

10. The exchanger as claimed in claim 1, it which is configured to cool the charge air of a motor vehicle engine.

11. A method for forming perturbators (15) on a perturbation wall (13) of an exchanger as claimed in claim 1, said method comprising the following steps:
producing double rows (17) of perturbators (15) as a single piece, and
producing single rows (17′) of perturbators (15) respectively as a single piece with dividing ribs (19).

12. The exchanger as claimed in claim 2, wherein a perturbation wall (13) comprises a predefined number of dividing ribs (19) arranged top to tail.

13. The exchanger as claimed in claim 12, wherein a perturbation wall (13) comprises a predefined number of dividing ribs (19) placed evenly.
